(19) United States
(12) Patent Application Publication
(10) Pub. No.: US 2025/0389327 A1
(43) Pub. Date: Dec. 25, 2025

(54) SHIFT DEVICE FOR A VEHICLE WITH A DIFFERENTIAL

(71) Applicant: ZF Friedrichshafen AG, Friedrichshafen (DE)

(72) Inventors: Alexander Thorwart, Langenargen (DE); Bernard Hunold, Friedrichshafen (DE); Michael Preuß, Friedrichshafen (DE); Niclas Raeder, Deggenhausertal (DE)

(73) Assignee: ZF Friedrichshafen AG, Friedrichshafen (DE)

(21) Appl. No.: 19/241,908

(22) Filed: Jun. 18, 2025

(30) Foreign Application Priority Data
Jun. 20, 2024 (DE) 10 2024 205 702.9

(51) Int. Cl. F16H 63/34; F16H 48/34; F16H 63/30

(52) U.S. Cl. CPC F16H 63/3425; F16H 48/34; F16H 63/3069; F16H 63/3466

(57) ABSTRACT

A shift device for a vehicle having a differential for distributing power to a first and second output shafts has a first shift position for locking a differential function, a second shift position for activating a parking lock function, and a third shift position as a neutral position. A servomotor with a drive shaft can displace a first positioning element to actuate a locking sleeve, and displace a second positioning element to actuate a locking pawl. The locking sleeve is rotationally fixed and axially displaceable on the first output shaft and is configured to connect the first output shaft to a differential carrier in a rotationally fixed manner in the first shift position to lock the differential function. The locking pawl can pivot and can engage a gearwheel in the second shift position to fix the differential carrier and activate the parking lock function.

### RELATED APPLICATIONS

This application claims the benefit of and right of priority under 36 U.S.C. § 119 to German Patent application no. 10 2024 205 702.9, filed on 20 Jun. 2024, the contents of which are incorporated herein by reference in its entirety.

### FIELD OF THE DISCLOSURE

The invention relates to a shift device for a vehicle with a differential for distributing drive power to a first output shaft and a second output shaft, wherein the shift device has at least a first shift position for locking a differential function and a second shift position for activating a parking lock function.

### BACKGROUND

For example, US 2017/0234428 A1 discloses a parking lock device for a vehicle having a transmission connected to a differential for transmitting rotational movement from the transmission to the front and rear driveshafts. The parking lock device comprises a locking element having a first state in which the locking element is arranged such that the differential of the vehicle is unlocked, and a parking lock is disengaged to allow independent rotational movement of the front and rear drive shafts of the vehicle relative to a fixed position on the vehicle. The locking element further has a second state in which the locking element is arranged to lock the differential of the vehicle in order to prevent independent rotational movement of the front and rear drive shafts of the vehicle relative to the fixed position on the vehicle, and in which the parking lock is released. The locking element further has a third state in which the locking element is arranged such that the differential of the vehicle is locked, and the parking lock is engaged to prevent rotational movement of the front and rear drive shafts of the vehicle relative to the fixed position on vehicle. Furthermore, an actuating element is provided for moving the locking element between the first, second, and third states, wherein the actuating element is moveable between three positions, each position being associated with the first state, the second state, and the third state. The locking element cannot be moved from the first state to the third state without first being moved to the second state to unlock the differential.

The purpose of the present invention is to provide an alternative shift device for a vehicle. In particular, the shift device should be compact and inexpensive to manufacture. The task is solved by the features of the independent patent claim. Advantageous embodiments are the subject of the dependent claims, the following description and the figures.

A shift vehicle according to the invention comprises a differential for distributing drive power to a first output shaft and a second output shaft, wherein the shift device has a first shift position for locking a different function, a second shift position for activating a parking lock function, and a third shift position which is provided as a neutral position between the first and second shift positions, wherein a servomotor with a drive shaft is arranged for displacing a first positioning element provided for actuating a locking sleeve and for displaying a second positioning element provided for actuating a locking pawl, wherein the locking sleeve is arranged on the first output shaft in a rotationally fixed and axially displaceable manner and is arranged to in the first shift position, to connect the first output shaft in a rotationally fixed manner to a differential carrier in order to lock the differential function, wherein the locking pawl is arranged so as to be pivotable about a pivot axis and is designed in the second shift position, to engage with a gearwheel which is at least indirectly connected to the differential carrier in order to fix the differential carrier in a stationary position and thereby activate the parking lock function. In particular, the differential carrier is also connected at least indirectly via a gearbox to a drive motor of the vehicle, wherein the drive motor generates drive power for driving the vehicle and feeds it into the differential via the differential carrier. For example, gearwheel is connected to the differential carrier in such a way that it cannot rotate. In particular, the gearwheel is designed as a gearing and is connected to the differential carrier in one piece.

Consequently, in the first shift position, only the lock sleeve is actuated and thus the differential function is locked, i.e., the differential lock is active, so that both output shafts rotate at the same speed. The first shift position is used, for example, when the vehicle is being driven off-road. In the second shift position, only the locking pawl is actuated and thus the parking lock function is active, i.e. the parking lock is engaged so that both shafts are prevented from rotating. The second shift position is used, for example, when parking the vehicle. In the third shift position, neither the locking sleeve nor the locking pawl is actuated, so that the drive power is distributed to both output shafts via the differential. The third shift position is used, for example, during normal vehicle operation. The shift device is compact and inexpensive, as both the parking lock and the differential lock can be activated and deactivated with a single servomotor.

The servomotor is preferably designed as an electric machine with a stator and a rotor, wherein the rotor generates a first rotational movement via the drive shaft to actuate the locking sleeve and a second rotational movement to actuate the locking pawl. The servomotor moves at least the first positioning element in a first direction of rotation and at least the second positioning element in a second direction of rotation. In particular, when returning from the first or second shift position to the neutral position, i.e., the third shift position, there is also a displacement of at least the respective positioning element that was used in the respective shift position. Alternatively, the drive shaft of the servomotor can be connected effectively to both positioning elements, at least indirectly, so that both positioning elements are moved simultaneously via the drive shaft of the servomotor, regardless of the direction of rotation.

According to one embodiment, the differential is designed as a bevel gear differential. A differential designed as a bevel gear differential has two wheel-side output elements, in particular a first output gear and a second output gear. The two output gears each have two compensating elements. The balancing elements are mounted in the differential carrier so that they can rotate about their own axis. The respective output gear is connected to the respective output shaft in a rotationally fixed manner. The differential is driven via the differential carrier, which is configured as a differential input shaft. The drive power fed into the differential gear is distributed to the output shaft and transmitted to the drive wheels of the output axis. The output shafts are designed to be connected to the drive wheels of the vehicle in a manner that allows them to transmit power. The respective output shaft can be connected directly or indirectly to the corresponding vehicle wheel via a joint shaft, a drive shaft, and/or a wheel hub.

According to one embodiment, the locking sleeve as a first axial gearing which, in the first shift position, engages, in a positive-manner, with a second axial gearing on the differential carrier. The first axial gearing is formed on the end face of the locking sleeve adjacent to the differential carrier. The second axial gearing is complementary to the first axial gearing and is arranged on an end face of the differential carrier facing the sliding sleeve. The first output shaft passes axially through both axial gearing.

According to one embodiment, a spring element is arranged on the locking sleeve to separate the locking sleeve from the differential carrier an unactuated state and to move it into a neutral position on the first output shaft. For example, the spring element is designed as a compression spring and is arranged coaxially with the first output shaft, in particular on the first output shaft. The spring element pre-tensions the locking sleeve in the axial direction. This also biases the first positioning element, the second positioning element, and the servomotor to a neutral position so that the spring force of the spring element automatically returns them to the third shift position when no actuating forces or holding forces are acting on the shift device.

According to one embodiment, the locking sleeve is arranged on the first output shaft so that it can move axially via a drive gearing. In other words, a toothed section is formed on an inner circumferential surface of the locking sleeve and on an outer circumferential surface of the first output shaft, thereby generating a rotationally fixed connotation between the locking sleeve and the first output shaft. When the first positioning element is moved, the sliding sleeve on the first output shaft also moves axially.

According to one embodiment, the second positioning element has a rod with an actuating element spring-mounted thereon, wherein the actuating element interacts with the locking pawl actuate it. In particular, the actuating element is spring-mounted on the rod via a spring element and is thus axially movable on the rod against a spring force. The rod can be connected directly or indirectly to the drive shaft of the servomotor. The actuating element can be designed as a cone, roller, or ball and serves to press the locking pawl into the gearing on the gearwheel to lock it. In particular, the servomotor moves the rod with the actuating element via the drive shaft, wherein the actuating element comes into contact with the locking pawl. When the locking pawl and the gearwheel are in a toot-to-tooth position, the actuating element is moved against the preload of the spring element on the rod and is thereby preloaded against the spring. The actuating element only moves the locking pawl when the tooth-to-tooth position of the locking pawl and gearwheel is released and the locking pawl can engage in a tooth gap on the gearwheel, wherein the actuating element is then moved toward the locking pawl by means of the spring force of the spring element arranged on the rod.

Preferably, when the parking lock function is activated, the actuating element is clamped in a guide at least by means of the locking pawl. In particular, the guide is arranged on the housing or a housing component and serves, for example, to guide the actuating element during the actuation process and to clamp the actuating element when the paring lock is engaged. By clamping the actuating element, the servomotor can be relieved, in particular de-energized, while the parking lock remains engaged. Alternatively, it is conceivable to provide a locking device on the drive shaft of the servomotor in order to at least maintain the second shift position when the servomotor is unloaded. In particular, the locking can be achieved by means of a spring element or a detent structure on the drive shaft.

According to one embodiment, the first positioning element is designed as a lever and is mounted on a housing component so that it can pivot. The servomotor thus acts on a first lever section, wherein the lever acts on the lock sleeve via a second lever section, wherein a third lever section is arranged between the first and second lever sections and is rotatably mounted on housing component. To transfer the force from the lever to the locking sleeve, a fork is attached to the lever, which has two bolts made of a smooth material. The bolts are offset by 180° to ensure even force distribution, thereby preventing the locking sleeve from jamming on the drive gearing on the first output shaft. Furthermore, the cylindrical shape of the bolts prevents jamming due to tilting of the lever.

According to one embodiment, the servomotor has a drive shaft with an eccentric cam which is designed to actuate the locking sleeve via the first positioning element in a first direction of rotation and to actuate the locking pawl via the second positioning element in a second direction of rotation which is opposite to the first direction of rotation. In other words, rotation of the drive shaft in a first direction of rotation causes the first positioning element move, thereby actuating the locking sleeve, whereas rotation of the drive shaft in a second direction of rotation causes the second positioning element to move, thereby actuating the locking sleeve. For example, both positioning elements are moved independently of the direction of rotation of the drive shaft, wherein the locking sleeve is actuated and the differential lock is thereby activated only when the drive shaft is rotated in the first direction of rotation, and wherein the locking pawl is actuated and the parking lock is thereby activated only when the drive shaft is rotated in the second direction of rotation.

According to embodiment, the first positioning element is designed as an axially displaceable shift fork with linear gearing and is in tooth engagement with the drive shaft of the servomotor via end gearing, wherein the second positioning element is operatively connected to an eccentric cam on the drive shaft of the servomotor, wherein rotation of the drive shaft in a first direction of rotation is arranged to actuate the locking sleeve via the first positioning element, and rotation of the drive shaft in a second direction of rotation, which is opposite to the first direction of rotation, is arranged to actuate the locking pawl via the second positioning element. In particular, according to embodiment, the first positioning element is axially displaceable as a whole, wherein the axial displacement of the first position element is effected via the linear gearing on the first positioning element. For example, the linear gearing is designed as a rack and is position-fixed, preferably connected to the shift fork in one piece. Preferably, the end gearing is arranged on the opposite side of the cam on the circumference of the drive shaft of the servomotor and extend by at least 40 degrees to a maximum of 270 degrees. This makes it possible, in particular, to create an actuator with a smaller diameter. The first positioning element and the second positioning element are effectively connected to each other via the drive shaft so that both positioning elements are always moved when the drive shaft rotates. This forced coupling of the two positioning elements means that additional elements designed to return the locking sleeve and the locking pawl to a neutral position, i.e. to the third shift position, can be omitted.

A vehicle according to the invention comprises a shift device according to the invention. The above definitions and explanations of technical effects, advantages, and advantageous embodiments of the device according to the invention also apply mutatis mutandis to the vehicle according to the invention. For example, the vehicle is designed as a motor vehicle.

### BRIEF DESCRIPTION OF THE DRAWINGS

Advantageous embodiments of the invention, which are explained below, are shown in the drawings, wherein identical or similar elements are provided with the same reference numerals. The following are shown:

FIG. 1 is a highly schematic sectional view of a shift device according to the invention in accordance with a first embodiment in a first shift position;

FIG. 2 is a highly schematic sectional view of the shift device according to the invention in accordance with the first embodiment in a third shift position;

FIG. 3a is a highly schematic sectional view of the shift device according to the invention in accordance with the first embodiment in a second shift position;

FIG. 3b shows a further highly schematic sectional view of the shift device according to the invention in accordance with the first embodiment in the second shift position;

FIG. 4a is a highly schematic sectional view of the shift device according to the invention in accordance with the first embodiment in the second shift position;

FIG. 4b shows a further highly schematic sectional view of the shift device according to the invention in accordance with the first embodiment in the second shift position;

FIG. 5 is a highly schematic sectional view of a shift device according to the invention in accordance with a second embodiment in a first shift position;

FIG. 6 is a highly schematic sectional view of shift device according to the invention in accordance with the second embodiment in a third shift position;

FIG. 7 is a highly schematic sectional view of the shift device according to the invention in accordance with the second embodiment in a second shift position;

FIG. 8 is another highly schematic representation of the shift device according to the invention in accordance with the first embodiment; and

FIG. 9 shows a vehicle with a shift according to the invention.

### DETAILED DESCRIPTION

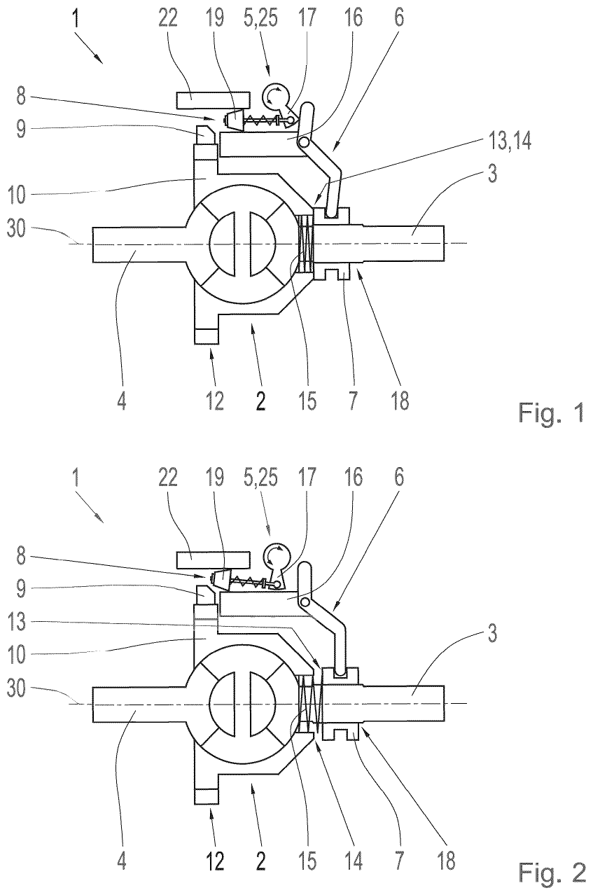

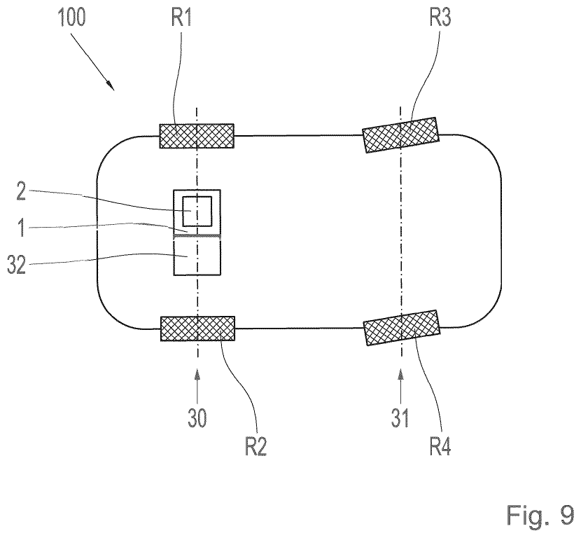

FIG. 1 shows a shift device 1 according to the invention for a vehicle 100 shown in FIG. 9. The shift device 1 comprises a differential 2 for distributing drive power from a drive motor 32 shown in FIG. 9 to a first output shaft 3 and a second output shaft 4 of the vehicle. The two output shafts 3, 4 are arranged on a common output axis 30. The shift device 1 further comprises a servomotor 5 with a drive shaft 25, a first positioning element 6, which is designed to actuate a locking sleeve 7, and a second positioning element 8, which is designed to actuate a locking pawl 9.

The servomotor 5 is designed as an electric machine and has an eccentric cam 17 on the drive shaft 25, which is designed to actuate the locking sleeve 7 via the first positioning element 6 in a first direction of rotation, in this case counterclockwise, and to actuate the locking pawl 9 via the second positioning element 8 in a second direction of rotation, which is opposite to the first direction of rotation, i.e., in this case clockwise. The first positioning element 6 is designed as a lever and is mounted on a housing component 16 so that it can pivot. The second positioning element 8 comprises a rod with a spring-loaded actuating element 19 attached thereto, wherein the actuating element 19 is guided in a guide 22 on the housing and is designed to interact with the locking pawl 9.

The shift device 1 has a first shift position for locking a differential function, a second shift position for activating a parking lock function, and a third shift position which is arranged as a neutral position between the first and second shift positions. FIG. 1 showing the first shift position of the shift device 1. From the neutral position, it is therefore possible to shift either to the first shift position to activate the differential lock function or to the second position to activate the parking lock function. A change from the first shift position to the second shift position or from the second shift position to the first shift position aways takes place via the third shift position. It is not possible to activate the differential lock function and the parking lock function simultaneously with the shift device 1. Consequently, the differential lock function and the parking lock function are combined in a single actuating device by means of the mechanical coupling of the two positioning elements 6, 8 to the electric drive.

According to FIG. 1, the servomotor 5 is pivoted counterclockwise relative to a neutral position as shown in FIG. 2, so that the locking sleeve 7 is actuated via the first positioning element 6. The locking sleeve 7 is rotationally fixed and axially displaceable on the first output shaft 3 via a drive gearing 18, and is designed to connect the first output shaft 3 rotationally to a differential carrier 10 of the differential 2 in the first shift position in order to lock the differential function. For this purpose, the locking sleeve 7 has a first axial gearing 13 which, in the first shift position, engages, in a positive-locking manner with a second axial gearing 14 on the differential carrier 10. Furthermore, a spring element 15 is arranged on the locking sleeve 7 to separate the locking sleeve 7 from the differential carrier 10 in an unactuated state and to move it into a neutral position on the output shaft 3. In this case, the spring element 15 is compressed due to the actuated locking sleeve 7. The neutral position of the locking sleeve 7, which is also the third shift position, is shown in FIG. 2.

FIG. 2 shows the third shift position, which is intended as the middle position between the first and second shift positions. Compared to FIG. 1, the servomotor 5 is pivoted clockwise so that both the first positioning element 6 and the second positioning element 8 are relieved. The spring force of spring element 15 pushes locking sleeve 7 out of the axial gearing 14 on the differential carrier 10, thereby releasing the differential lock. In this third shift position, neither the differential lock nor the parking lock is engaged, making this shift position particularly suitable for normal vehicle operation.

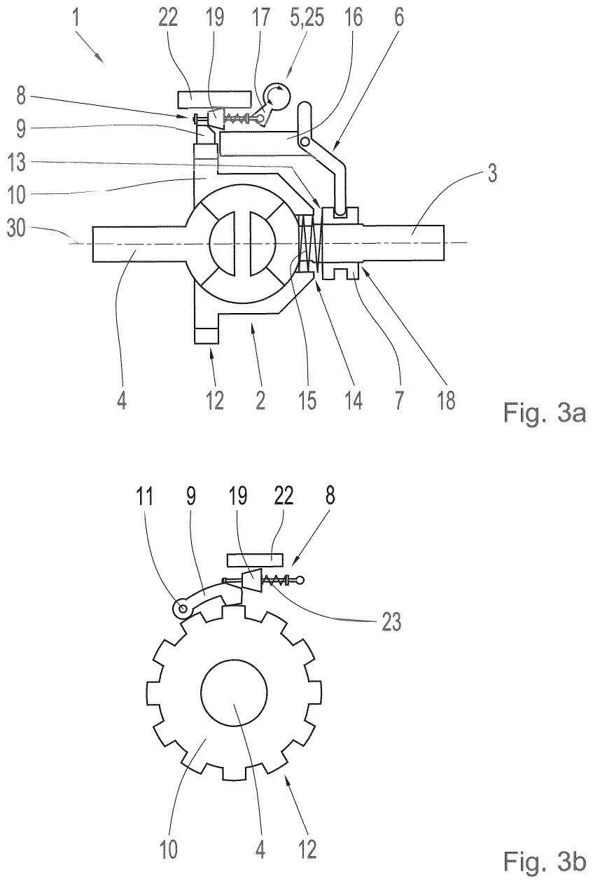

FIGS. 3a and 3b show the second shift position of the shift device 1, in which the parking lock is activated via the servomotor 5 but is not yet engaged because the locking pawl 9 is not in tooth engagement with a gearwheel 12 designed as a ratchet wheel. As can be seen n FIG. 3b, the locking pawl 9 can be pivoted about a pivot axis 11 and is designed to engage, in the second shift position, in the gearwheel 12, which is connected in this case in a rotationally fixed manner to the differential carrier 10, in order to fix the differential carrier 10 in a stationary position and thereby activate the parking lock function. The servomotor 5 is pivoted clockwise to FIG. 2, wherein the second positioning element 8 is pressed via the cam 17 on the drive shaft 25 of the servomotor 5 in the direction of the locking pawl 9. As can seen in FIG. 3b, there is a tooth-to-tooth locking position between the locking pawl 9 and gearwheel 12. This causes the actuating element 19 to be displaced axially on the rod of the second positioning element 8 against a spring 23 of the second positioning element 8. In other words, the actuating element 19 is biased against the locking pawl 9 so that it is pressed into a tooth gap on the gearwheel 12 when the gearwheel 12 rotates. For example, such rotation is achieved by rolling the vehicle backward, wherein the differential carrier 10 with the gearwheel 12 is rotated by the required angle so that the locking pawl 9 can engage with the gearwheel 12. The actuating element 19 is designed as an actuating cone in the present embodiment. The second output shaft 4 is guided axially through the gearwheel 12 and rotates relative to it.

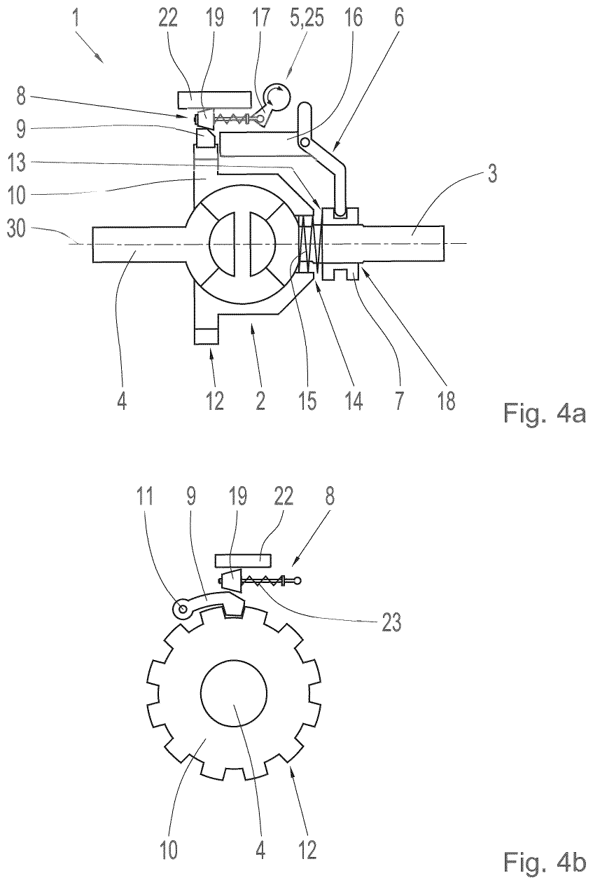

FIGS. 4a and 4b show the second shift position of the shift device 1, wherein the locking pawl 9 is in tooth engagement with the gearwheel 12 and the parking lock is thus engaged. Compared to FIGS. 3a and 3b, the actuating element 19 has been moved axially on the rod of the second positioning element 8 by means of the spring 23 of the second positioning element 8, so that the locking pawl 9 is pressed into the tooth gap on the gearwheel 10 via the actuating element 19. In this activated state of the parking lock function, the actuating element 19 is clamped in the guide 22 on the housing via the locking pawl 9, thereby locking the parking lock.

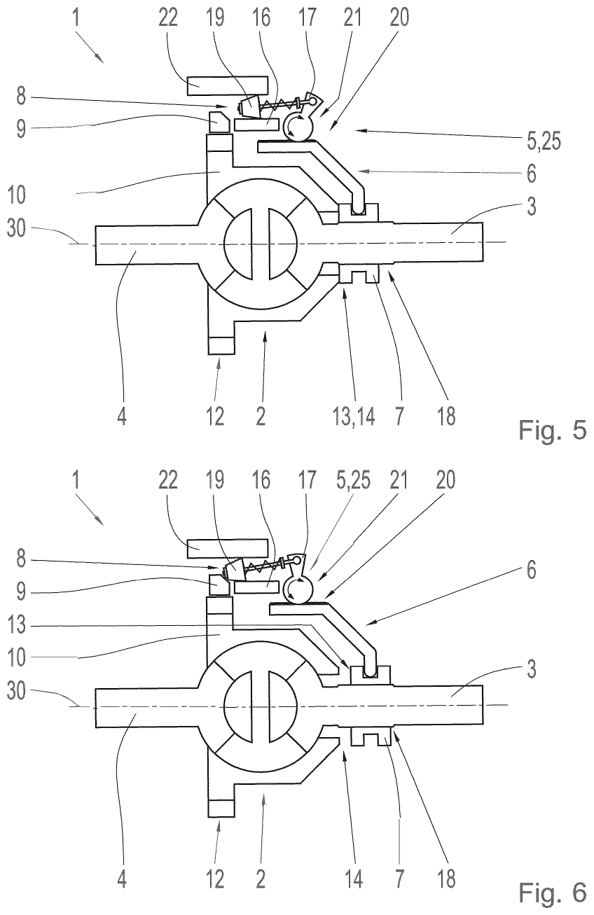

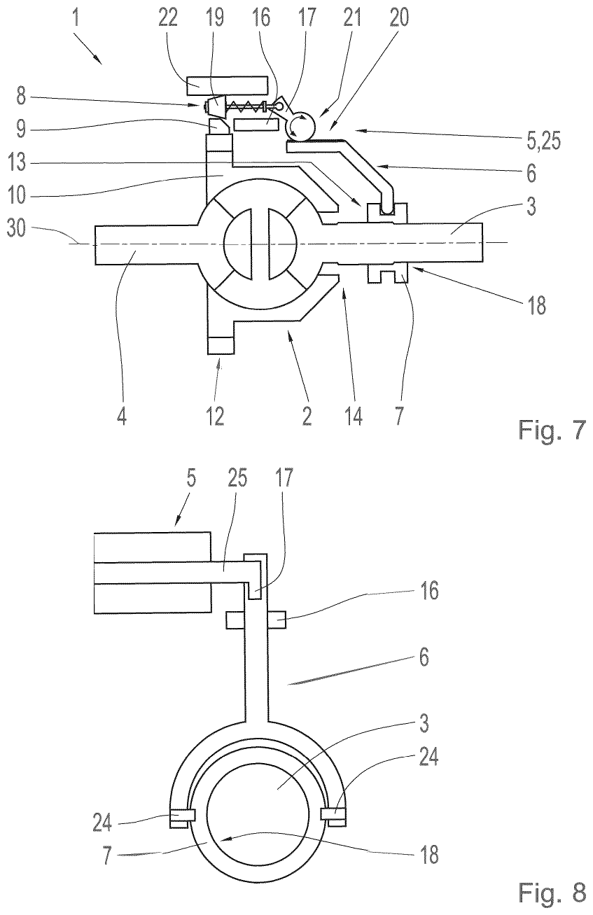

FIG. 5, FIG. 6, and FIG. 7 show a second embodiment of the shift device 1. The second embodiment of the shift device 1 essentially corresponds to the first embodiment of the shift device 1 referred to above, with differences between these two embodiments being explained below. Firstly, the first positioning element 6 is not designed as a lever but as an axially displaceable shift fork with linear gearing 20, wherein the linear gearing 20 is in tooth engagement with end gearing 21 on the drive shaft 25 of the servomotor 5. Consequently, the first positioning element 6 is not actuated via the cam 17 on the drive shaft 25 of the servomotor 5, but via the tooth engagement on the drive shaft 25. The second positioning element 8 continues to be actuated via the cam 17 on the drive shaft 25 of the servomotor. When drive shaft 25 rotates, both positioning elements 6 and 8 are therefore always displaced.

According to FIG. 5, the drive shaft 25 of the servomotor 5 is pivoted clockwise relative to a neutral position so that the locking sleeve 7 is actuated via the first positioning element 6. The locking sleeve 7 is rotationally fixed and axially displaceable on the first output shaft 3 via a drive gearing 18, and is designed to connect the first output shaft 3 rotationally to the differential carrier 10 of the differential 2 in the first shift position in order to lock the differential function. For this purpose, the locking sleeve 7, as in the first embodiment, has a first axial gearing 13 which, in the first shift position, engages, in a positive-locking manner, with a second axial gearing 14 on the differential carrier 10. Due to the forced coupling between the first positioning element 6, the second positioning element 8, and the drive shaft 25 of the servomotor 5, a spring element on the locking sleeve 7 can be omitted. This is because when the drive shaft 25 of the servomotor 5 is rotated clockwise, the first positioning element 6 is displaced axially in such a way that the locking sleeve 7 is pulled out of the axial gearing 14 on the differential carrier 10 and positioned in a neutral position on the first output shaft 3.

FIG. 6 shows the neutral position of the locking sleeve 7, which is also the third shift position. Compared to FIG. 5, the servomotor 5 is pivoted counterclockwise so that both the first positioning element 6 and the second positioning element 8 are relieved. Consequently, neither the differential lock nor the parking lock is engaged in the present third shift position.

FIG. 7 shows the second shift position of the shift device 1, wherein the parking lock is activated and engaged via the servomotor 5. In the second shift position, the locking pawl 9 engages in the gearwheel 12, which is connected in a rotationally fixed manner to the differential carrier 10, in order to fix the differential carrier 10 in a stationary position and thereby activate the parking lock function. The servomotor 5 is pivoted counterclockwise relative to FIG. 6, wherein the second positioning element 8 is pressed via the cam 17 on the drive shaft 25 of the servomotor 5 in the direction of the locking pawl 9. The locking pawl 9 was pressed into the tooth gap or the gearwheel 10 via the actuating element 19. In this activated state of the parking lock function, the actuating element 19 is clamped in the guide 22 on the housing via the locking pawl 9, thereby locking the parking lock.

FIG. 8 shows another sectional view of a portion of the first embodiment of the shift device 1. This illustration shows how the locking sleeve 7 is connected to the first positioning element 6, which is designed as a lever. The first positioning element 6 is mounted on a housing component 16 so that it can pivot, with the servomotor 5 acting via the drive shaft 25 with the cam 17 on a first lever section, with the first positioning element 6 acting with a second lever section on the locking sleeve 7. A third lever section, which is arranged between the first and second lever sections, is rotatably mounted on the housing component 16. To transfer power from the lever to the locking sleeve 7, a fork is attached to the lever, which supports two bolts 24 made of a sliding material. The bolts 24 are arranged at 180° on the fork to ensure even force transmission, thereby preventing the locking sleeve 7 from jamming on the drive gearing 18 on the first output shaft 3. Furthermore, the cylindrical shape of bolts 24 prevents jamming due to tilting of the lever.

FIG. 9 shows a vehicle 100 with a first axis which represents the drive axis 30 according to the previous figures, with two vehicle wheels R1, R2 and a second axis 31 with two vehicle wheels R3, R4. In the present embodiment, the first axis is designed as the rear drive axis of the vehicle 100 and is equipped with a drive unit. The drive unit comprises a drive motor 32, which is designed as an electric machine and is set up to generate drive power, and a shift device 1 according the invention with a differential 2 for distributing the drive power to the first wheel R1 and the second wheel R2. The vehicle 100 is therefore designed as an electric vehicle, i.e., a vehicle that can be actuated electrically.

### REFERENCE NUMBERS

1 shift device
2 differential
3 first output shaft
4 second output shaft
5 servomotor
6 first positioning element
7 locking sleeve
8 second positioning element
9 locking pawl
10 differential carrier
11 pivot axis
12 gearwheel
13 first axial gearing
14 second axial gearing
15 spring element
16 housing component
17 cam
18 drive gearing
19 actuating element
20 linear gearing
21 end gearing
22 guide
23 spring
24 bolt
25 drive shaft
30 output axis
31 second axis
32 drive motor
100 vehicle

1. A shift device (1) for a vehicle (100) with a differential (2) for distributing a drive power to a first output shaft (3) and a second output shaft (4), wherein the shift device (1) has a first shift position for locking a differential function, a second shift position for activating a parking lock function, and a third shift position provided as a neutral position between the first shift position and the second shift position, the shift device comprising:
a locking sleeve arranged on the first output shaft (3) in a rotationally fixed and axially displaceable manner, the locking sleeve configured to connect the first output shaft (3) to a differential carrier (10) in a rotationally fixed manner in the first shift position in order to lock the differential function;
a locking pawl pivotable about a pivot axis (11) and is configured to engage, in the second shift position, in a gearwheel (12) which is at least indirectly connected to the differential carrier (10) in order to fix the differential carrier (10) in a stationary position and thereby activate the parking lock function;
a first positioning element;
a second positioning element configured for actuating the locking pawl; and
a servomotor (5) with a drive shaft (25) configured to displace the first positioning element (6), the servomotor configured for actuating the locking sleeve (7), and configured to displace the second positioning element (8).

2. The shift device (1) according to claim 1, wherein the locking sleeve (7) has a first axial gearing (13) which, in the first shift position, engages, in a positive-locking manner, in a second axial gearing (14) on the differential carrier (10).

3. The shift device (1) according to claim 1, comprising a spring element (15) on the locking sleeve (7) and configured to separate the locking sleeve (7) from the differential carrier (10) in an unactuated state and to displace the locking sleeve into a neutral position on the first output shaft (3).

4. The shift device (1) according to claim 1, wherein the locking sleeve (7) is axially movable along the first output shaft (3) via a drive gearing (18).

5. The shift device (1) according to claim 1, wherein the second positioning element (8) comprises a rod with an actuating element (19) spring-loaded thereon, wherein the actuating element (19) cooperates with the locking pawl (9) in order to actuate the actuating element (19).

6. The shift device (1) according to claim 5, wherein the actuating element (19) is clamped in a guide (22) at least via the locking pawl (9) in an activated state of the parking lock function.

7. The shift device (1) according to claim 1, wherein the first positioning element (6) is configured as a lever and is pivotably mounted on a housing component (16).

8. The shift device (1) according to claim 1, wherein the servomotor (5) has an eccentric cam (17) on the drive shaft (25), the eccentric cam configured to actuate the locking sleeve (7) in a first direction of rotation via the first positioning element (6) and to actuate the locking pawl (9) in a second direction of rotation, which is opposite to the first direction of rotation, via the second positioning element (8).

9. The shift device (1) according to claim 1, wherein the first positioning element (6) is configured as an axially displaceable shift fork with a linear gearing (20) and is in tooth engagement with an end gearing (21) on the drive shaft (25) of the servomotor (5), wherein the second positioning element (8) is operatively connected to an eccentric cam (17) on the drive shaft (25) of the servomotor (5), wherein the rotation of the drive shaft (25) in a first direction of rotation is configured to actuate the locking sleeve (7) via the first positioning element (6), and wherein the rotation of the drive shaft (25) in a second direction of rotation, which is opposite to the first direction of rotation, is configured to actuate the locking pawl (9) via the second positioning element (8).

10. A vehicle (100) with [a] the shift device (1) according to claim 1.
